(19) United States
(12) Patent Application Publication
(10) Pub. No.: US 2013/0230833 A1
(43) Pub. Date: Sep. 5, 2013

(54) Method for Enhanced Memorization and Retention of Consecutive Text

(71) Applicant: Adam S. Hewett, Chicago, IL (US)

(72) Inventor: Adam S. Hewett, Chicago, IL (US)

(73) Assignee: VITREPIXEL HOLDINGS, LLC, Chicago, IL (US)

(21) Appl. No.: 13/412,246

(22) Filed: Mar. 5, 2012

(51) Int. Cl. G09B 19/00

(52) U.S. Cl. 434/236

(57) ABSTRACT

A method for improving the memorization and recall of scripts, speeches, prose or other consecutive text. The invention provides a way to improve memorization through review strategies, hinting strategies and by dynamically adapting to the user. It also provides a way to use mnemonics to improve memorization, retention and to reduce memory loss due to the stress. It further provides a way to use spaced repetition techniques with consecutive text in order to ensure continued retention of learned material.

### FIELD OF INVENTION

The present invention relates to assisted learning; specifically, the invention relates to a method of improving the memorization process and retention of speeches, scripts, prose, and any other form of consecutive text, using spaced repetition, mnemonics and by dynamically adapting to the user.

### BACKGROUND OF THE INVENTION

The present invention is an assisted learning method, and although many highly effective assisted learning methods exist, none have touched on a more effective way to memorize large, consecutive bodies of text verbatim. As will be explained, learning methods thus far have focused primarily on learning facts, languages or arithmetic. Therefore, anyone whose task it is to memorize a large body of consecutive text will be left using the age-old method of simple repetition. Politicians memorizing speeches, actors memorizing scripts, students memorizing prose—all these professions and more struggle with an antiquated memorization process.

Ironically, the first assisted learning method found in history was invented to help with public speaking. This method was called the “Loci” nm emonic system and was invented around 500 BC by Simonides. It involves mentally visualizing to-be-remembered items in specific locations, such as in rooms throughout a house, or places in a city. When an item needs to be recalled, a person need only “go back” to that specific location in their mind and retrieve the memory from there. This method is ingenious in that it uses both visual and spatial memory to enhance the recall of verbal memories. Verbal memory is relatively weak in comparison, and visual memory is much more resistant to memory loss during stressful periods (such as “Stage Fright”). Simonides used the method to remember the general topics of his speeches so that he could always find his way back from a tangent and always knew that he had said all he wanted to say, and in the order he wanted to say it. The method was widely used until Renaissance times.

The problem with using the “Loci” method is that it is designed to only keep track of a limited number of general topics, not to memorize information verbatim. The method is inherently limited in that the there are only a limited number of rooms in a house and a limited number of notable locations in a city. Therefore, the majority of the memorization of a speech (recited verbatim) is still done without any assistance. The “Loci” system is better suited for ad-lib speeches or presentations, where there is little or no information that needs to be remembered verbatim.

Another method for helping with public speaking is an adaptation of the “Link” or “Chain” mnemonic system. In this system, each to-be-remembered item is mentally visualized as interacting with the subsequent item. This system is typically used to memorize long lists of words or items, such as a shopping list. However, it can be adapted for other purposes. An adaptation of this system for use in behavioral modification is used in U.S. Pat. No. 4,734,038. It can also be adapted to help remember the topics of a speech, similar to the “Loci” system mentioned above.

The “Chain” system does not suffer the same inherent limitations of the “Loci” system, but is still unsuited for memorizing material verbatim without further assistance. Memorizing material verbatim—not just the general topics—involves breaking the material down into groups and assigning a mnemonic visual aid to each group. This is extremely difficult to do with printed material, as each page (indeed: often each sentence!) must inevitably fill up with notations and highlights, making it virtually unreadable and difficult to review.

With the advent of computers, a new type of assisted learning system has become feasible. Using a database to store user performance data, and one or more algorithms to adapt to that data, a computer can be used to predict when a user is most likely to forget previously learned material. Using this data, it can allow the user to review only that information which needs to be reviewed, and nothing more. This is a major improvement on simple repetition, as it both a) saves time by reducing the number of items that need to be reviewed, and b) ensures that the items being reviewed are ones that need reviewing.

This method is often called “Spaced Repetition” and can be found in U.S. Pat. Nos. 7,052,277 and 6,419,496 and 6,447,299.

While the benefits of current incarnations of spaced repetition are indisputable, they are not suitable for working with consecutive text. For this purpose, they suffer from four major disadvantages: 1) They typically randomize the sets of information being memorized, making the memorization of a script (which has a linear progression) impossible. 2) They tend to be in a question and answer format unsuitable for learning speeches or acting lines. 3) They do not allow the viewing of past and/or future “lines”, so as to allow the user to easily find his or her place when a review is scheduled in the middle of a speech or script. 4) They tend to require too much feedback, making natural rehearsal of a speech or script impossible.

Furthermore, existing methods do not help in the memorization of material so much as they do in the retention of already learned material. Therefore, one or more additional components are needed in order for such a system to be complete and to be truly useful for the purpose of memorizing large amounts of consecutive text.

One method helpful in both the memorization and recall process is the use of hints, such as only displaying the first letter in each word, as in U.S. Pat. No. 7,357,640. Hints reduce the amount of information one must memorize on each review, and, failing a full recall of an item, hints can help jog the memory, avoiding a full-on memory lapse.

However, the use of hints alone cannot enable the memorization of large amounts of consecutive information. In fact, the use of hints thus far has been limited primarily to the assisted recall of facts in a question and answer format. Further, the same hints will likely not be available during the recitation of a speech or the reading of one's lines, so while hints are helpful in the beginning, one must still be able to recall information accurately without the use of them in order to be fully prepared for a presentation. Therefore, the use of hints must be limited, their use must be analyzed and they must be presented in a way specific to consecutive text in order to be useful for this purpose.

### SUMMARY OF INVENTION

The invention is summarized below only for purposes of introducing embodiments of the invention. The ultimate scope of the invention is to be limited only to the claims that follow the specification.

The present invention solves the described problems by creating a comprehensive assisted learning method specifically designed for speeches, acting scripts, prose, poetry, and any other form of consecutive text.

The body of text is broken down into comparatively tiny groups of text and each group is assigned a mnemonic aid. Groups are laid out in a sequence so that the user can view each group individually and with other adjacent groups. It is also laid out so the groups are sequenced in order. The interface is fluid enough that the user can easily review the entire body of text without stopping, despite the text being broken down into groups.

Reviews of just-learned material are regularly enforced and their schedule based on an understanding of human memory and on past user performance.

Performance is judged by user interaction wherein a user can indicate if a group is particularly hard to recall.

During reviews, hinting strategies are used to reduce frustration and to help recall. An algorithm is used to limit and optimize their use.

Finally, a schedule is created to enforce the review of both the entire body of text and of specific groups based on an understanding of human memory and on past user performance. The purpose of this algorithm is to space out the repetition such that material is only reviewed just as the user is about to forget it, thus limiting the amount of repetition needed while still maintaining long-term memory retention.

Using the above method, a large body of text can be memorized, retained and easily recalled to memory even under stressful conditions.

Use of the words “function” or “means” in the specification and claims is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function. Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

Further objects and advantages of the present invention will become apparent from the consideration of the drawings and ensuing description. The description of the invention that follows, together with the accompanying drawings, should not be construed as limiting the invention to the example shown and described, because those skilled in the art to which this invention pertains will be able to devise other forms thereof within the ambit of the appended claims.

### BRIEF DESCRIPTION OF DRAWINGS

FIG. 1—A flow chart of the functions that may be used by the present invention.

FIG. 2—An example of a visual display allowing for the reduction a body of text into smaller groups.

FIG. 3—An example of a visual display for assigning mnemonic aids to each group.

FIG. 4—An example of a visual display for viewing, memorizing and interacting with the groups.

FIG. 5—An example of a visual display wherein a hinting strategy is used.

FIG. 6—A diagram illustrating the use of regular reviews and how such reviews can adapt to user performance.

FIG. 7—A diagram illustrating the use of regular reviews and larger reviews to ensure memorization.

FIG. 8—An example of a visual display for enforcing reviews of just-learned material.

FIG. 9—A diagram illustrating how problem areas are designated.

FIG. 10—A diagram illustrating where a review will start prior to the scheduled review of a problem area.

### DETAILED DESCRIPTION

It is to be understood that the descriptions below are merely illustrative of the presently preferred embodiment of the invention and that no limitations are intended to the detail of construction or design herein shown other than as defined in the appended claims.

### Preferred Embodiment

Since most assisted learning is now done on a computer or on a smart phone, the preferred embodiment of this invention is as a web-based software program capable of running on both. It will be stored on an online computer server equipped with memory, hosting software, database software and a link to the internet. The preferred embodiment also includes user input in the forms of a computer with memory and interactive input (keyboard and mouse), or a smart phone with memory and touch screen capabilities, and a conventional visual display.

### DEFINITIONS

Body of Text

The body of text is considered the entirety of what the user currently desires to memorize. For example, a body of text could be a poem, an acting script, a speech or prose.

Group

A group (or part) is a small portion of the body of text. The first step of the preferred embodiment is to break the body of text down into more manageable groups of text that are to be memorized and handled individually, yet still displayed consecutively.

Mnemonic Aid

In the preferred embodiment, a mnemonic aid is intended to be a word or series of words representing a visual cue for the user. For example, if the text of a group starts with “Indeed there will be time,” the word “clock” could be used a mnemonic aid, which would cue the user on the use of “time” in the sentence.

In the preferred embodiment, the mnemonic aids are designed to be linked together using the “Chain” mnemonic system, where each mnemonic visual interacts with the preceding and subsequent visual, forming a “chain” of visuals. This system is typically used to remember long lists of words, and is a proven method of doing so. In the preferred embodiment, this system is used to remember a long series of cues for each group of text. This assists users in remembering what the next group is and assists them in keeping their place in the body of text. It is also very helpful for reducing memory loss due to stage fright, since visual memory is not as subject to stress-based memory loss as verbal memory is.

Problem Indicator

In the preferred embodiment, the problem indicator is a button near the top of the display which is used to indicate if a user is experiencing a problem recalling a certain group. When a group has been indicated as having a problem or of being problematic, it will be because the user has clicked this button at least once while viewing that group.

Software Model

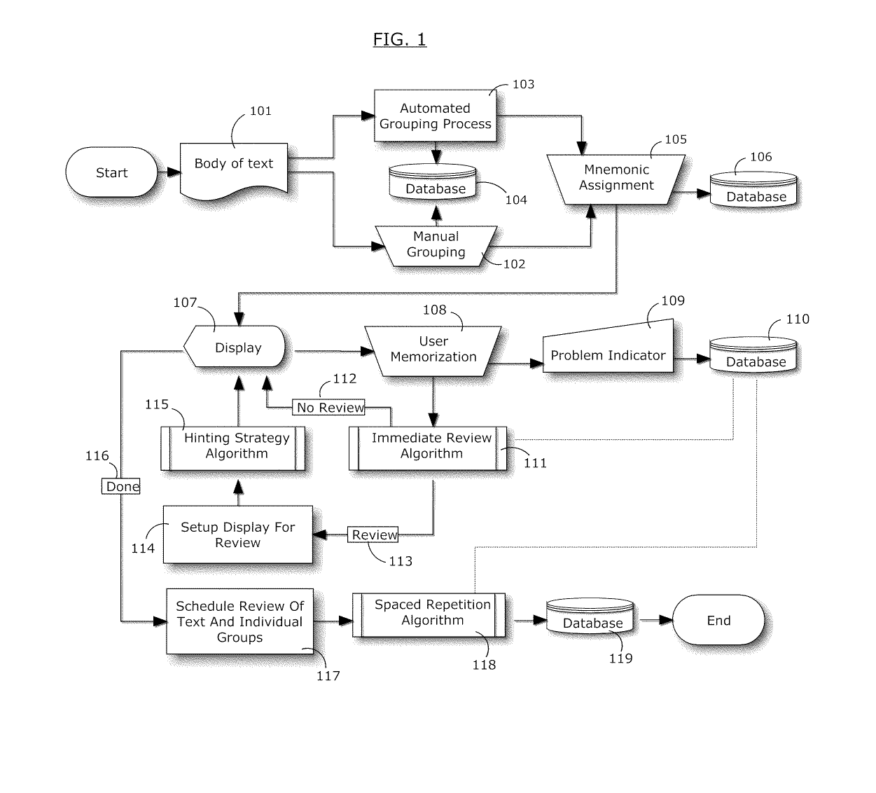

FIG. 1 depicts a logical flow chart of the functions to be performed in accordance with the present invention. Each function is given a more detailed description below. The algorithms mentioned will be explained further below.

First, the body of text (101) is divided into many smaller groups of text (sometimes, “parts”). Each group may contain a single line, a part of a line, or multiple lines related in some way. The text may be divided manually (102) or may be automatically grouped (103). Once divided, these groups are then saved to the database (104).

Next, each group is manually assigned a mnemonic aid by the user (105) that is related to the text in that group, such that the aid will act as a cue for that information. The mnemonic aids help the user to recall the information, act to help keep the user's place in the body of text, and also act to help reduce memory loss from stage fright. Once assigned, the groups with their mnemonic aids will be saved to the database (106).

Next, the groups are laid out on a display (107) such that they can be reviewed consecutively.

After the display is arranged, the user starts the memorization process (108) by viewing each group, committing to memory the text and the related mnemonic aid. The user has the option of indicating if a group is problematic (109), or hard to recall. The data from these indications is saved to a database (110). The analysis of this data is used in the Immediate Review Algorithm (111) and Spaced Repetition Algorithm (118).

After each group is viewed and committed to memory, the system will check to see if a review of multiple previous groups is warranted. The Immediate Review Algorithm (111) is used to determine if a review of the just-learned material should be recommended.

If a review is not recommended, the user is taken back to the display where the next group is shown (112). If a review is recommended (113), the display is set up for a review (114). Hinting strategies can also be used with each group during review, and the Hinting Strategy Algorithm (115) is be used to determine if a hinting strategy is appropriate and, if so, which hinting strategy should be used. Once a hinting strategy is chosen, it will be prepared with the display for review.

After the display is done showing all the groups (116), a review of the entire text, as well as reviews of individual groups, will be scheduled (117) using the Spaced Repetition Algorithm (118). The schedule will then be saved to the database (119).

Operation

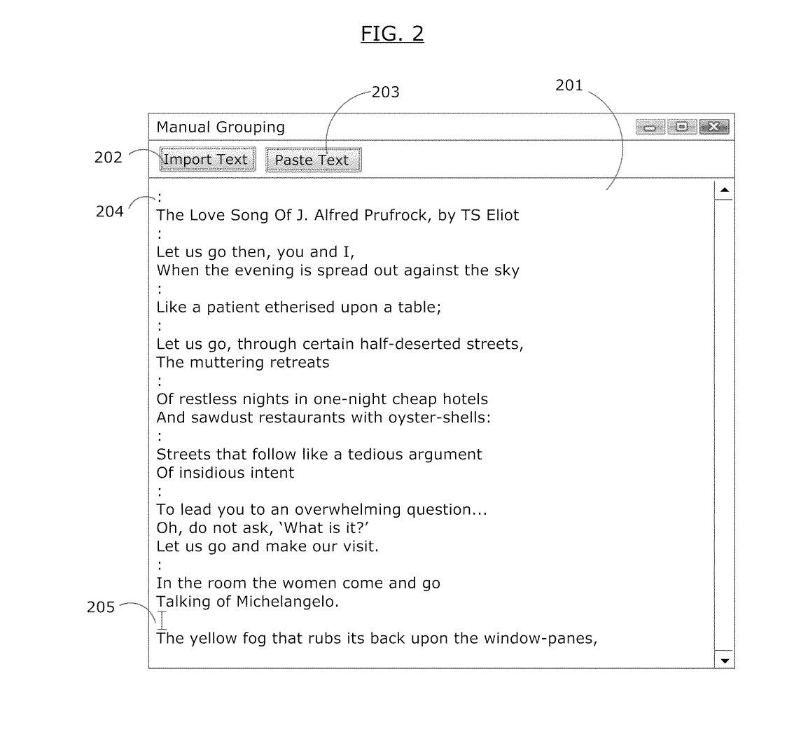

FIG. 2 depicts a software interface that could be used to operate the part of the present invention where the body of text is grouped manually into smaller groups by the user. This process is referred to as “Manual Grouping” in FIG. 1 (102). The user has three options for bringing a body of text into the software. The first is to simply type the text in manually into a text box (201) using a keyboard. The next option is to import the text (202) as a DOC, TXT or other kind of text-based document. The third option is to paste the text (203) from the clipboard. In the preferred embodiment, one or more lines are divided into groups by separating them using a colon (204). To create a new group, the user need only create a new line (205) after the last line of an intended group, and insert a colon. The lines are intended to be separated based on similarities between the lines, such as rhyming words, complementary concepts, or on the user's future plans for the mnemonic assignments of each group.

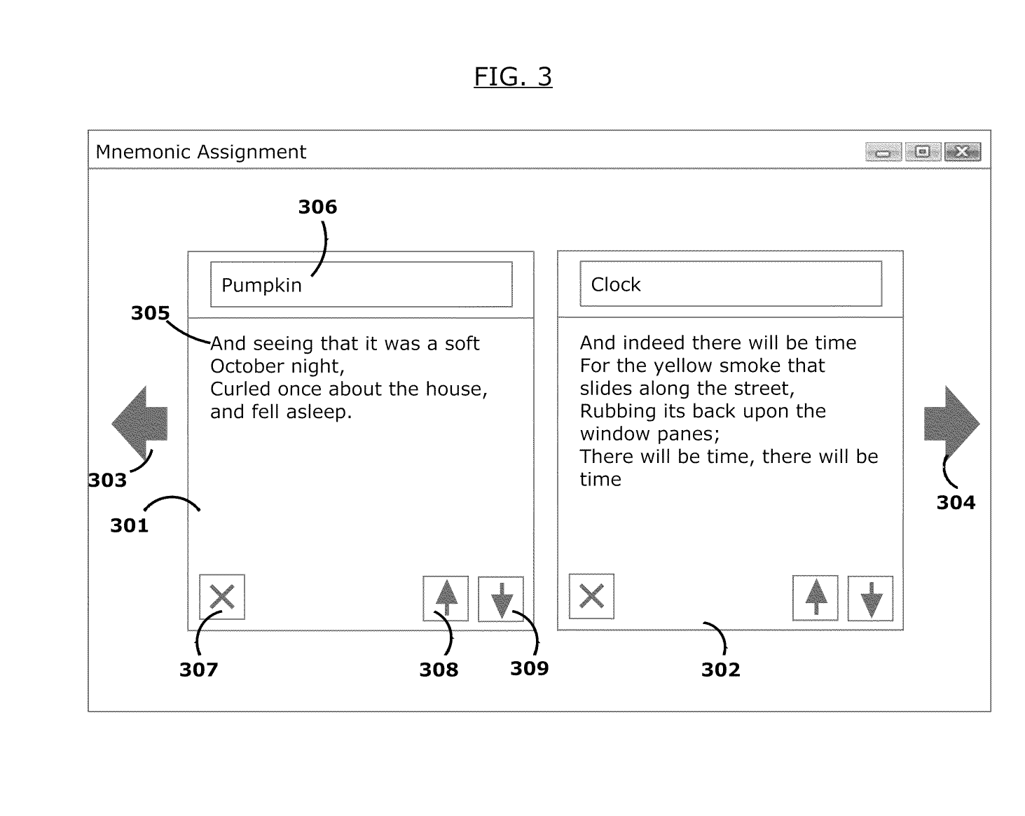

FIG. 3 depicts a software interface that could be used for the part of the present invention where mnemonic aids are assigned. This process is referred to as Mnemonic Assignment in FIG. 1 (105). Each group is displayed in a separate box (301), meant to be presented consecutively with the subsequent group(s) (302), or with the preceding group(s). The user can navigate between groups using the back (303) and forward (304) buttons, or by using the “swipe” function on a mobile device. The user can view the text of a group (305) and, based on the text, determine what the mnemonic aid will be. Once determined, the mnemonic aid is typed into a text box at the top (306). At the bottom of each group's display box, there are three additional options: 1) a button to delete the current group (307), a button to move a line from the next group to the present group (308) and a button to move a line from the present group to the next group (309). These are options enable the user to easily adjust groups according to changes in mnemonic strategy of the user if such changes occur during this process.

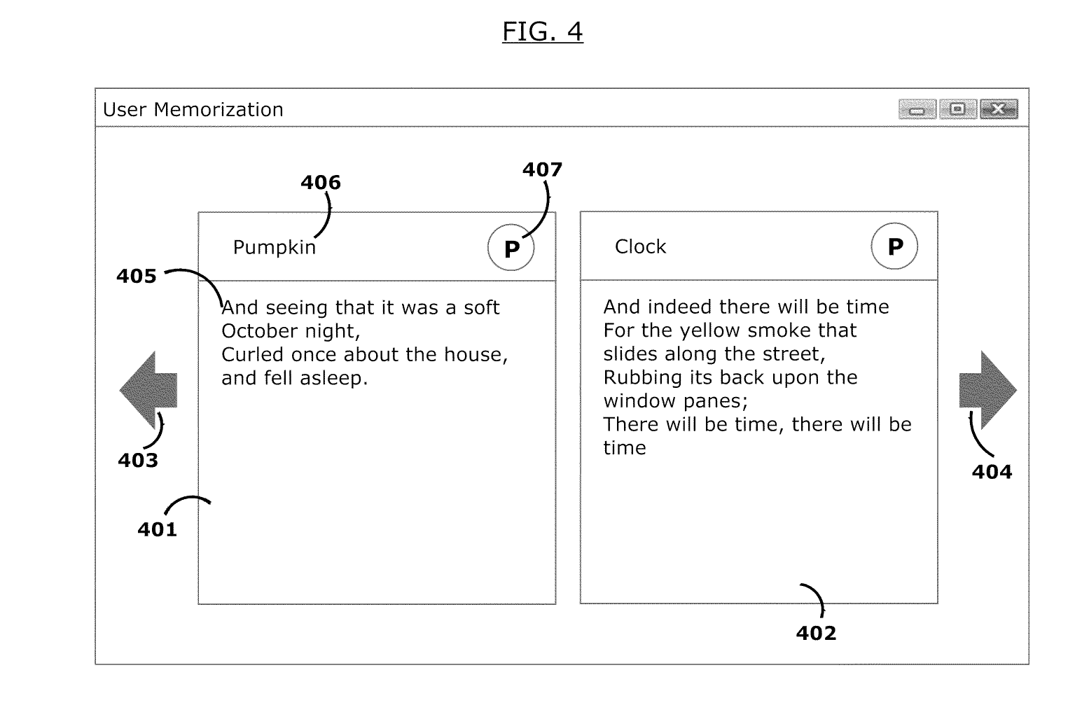

FIG. 4 depicts a software interface that could be used for the part of the present invention where user memorization occurs. This process is called User Memorization in FIG. 1 (108). Each group is displayed in a separate box (401), meant to be presented consecutively with the subsequent group(s) (402), or with the preceding group(s). The user can navigate between groups using the back (403) and forward (404) buttons, or by using the “swipe” function on a mobile device. The user can view the text of a group (405) and the associated mnemonic aid (406). The user will commit both the text and the mnemonic aid to memory as best as he or she can and move on to the next group. This display is fluid enough to allow the user to easily progress through the entire body of text without stopping. It also easily allows viewing of groups preceding the one being viewed by the user, which is important in order for the user to be able to find his or her place in the body of text. At the top of each group is a button (407) that can be used to indicate that a group is particularly problematic to memorize or recall during reviews. The button is prominent and easily clicked, so that the user can still progress through the rest of the body of text without too much delay. The use of this button is called “Problem Indicator” in FIG. 1. (109) and the use of the button is collected as data to be used in a number of algorithms important to the preferred embodiment of the present invention.

FIG. 5 depicts a software interface that could be used for a part of the present invention where user review and hinting strategies occurs. This process is called Setup Display For Review in FIG. 1 (114). Each group is displayed in a separate box (501), meant to be presented consecutively with the subsequent group(s) (502), or with the preceding group(s). The user can navigate between groups using the back (503) and forward (504) buttons, or by using the “swipe” function on a mobile device. In this review process, the user is expected to recall the text of each group using either a hinting strategy, such as displaying the first letter of each word (505), or by recalling the text with little to no hints (506). Whether a hint is displayed, and if so, which hinting strategy is used, depends on the Hinting Strategy Algorithm. If a user has trouble recalling the text of a certain group, the “Problem Indicator” button (507) can be clicked to alert the system to a problem, so the data can be used in other algorithms throughout the program.

Immediate Review Algorithm

When memorizing material, it is a common technique to re-review just-learned material to solidify the material in memory. In the preferred embodiment of the present invention, the Immediate Review Algorithm (IRA) is used to determine when reviews will be recommended to the user. The IRA consists of two phases which repeat while a script is being memorized or reviewed.

The first phase involves recommending a review that will typically range from three to eight groups preceding the current group. This number shall be referred to as the R number. The R number will depend on two metrics: 1) The content of the groups: the IRA assumes that the more text there is in a group, the harder it will be to memorize and therefore the sooner is should be reviewed, thus decreasing the R number. 2) Performance on past reviews: the IRA continually tests the user by adding to or subtracting from R and tallying the number of times the user indicates a problem via the Problem Indicator. For example, if a problem is indicated during a review where R=7, the IRA may decide the next review should be R=6 during the next review. Similarly, if no problems are experienced with R=5, the IRA may decide to challenge the user by increasing it to R=6 during the next review.

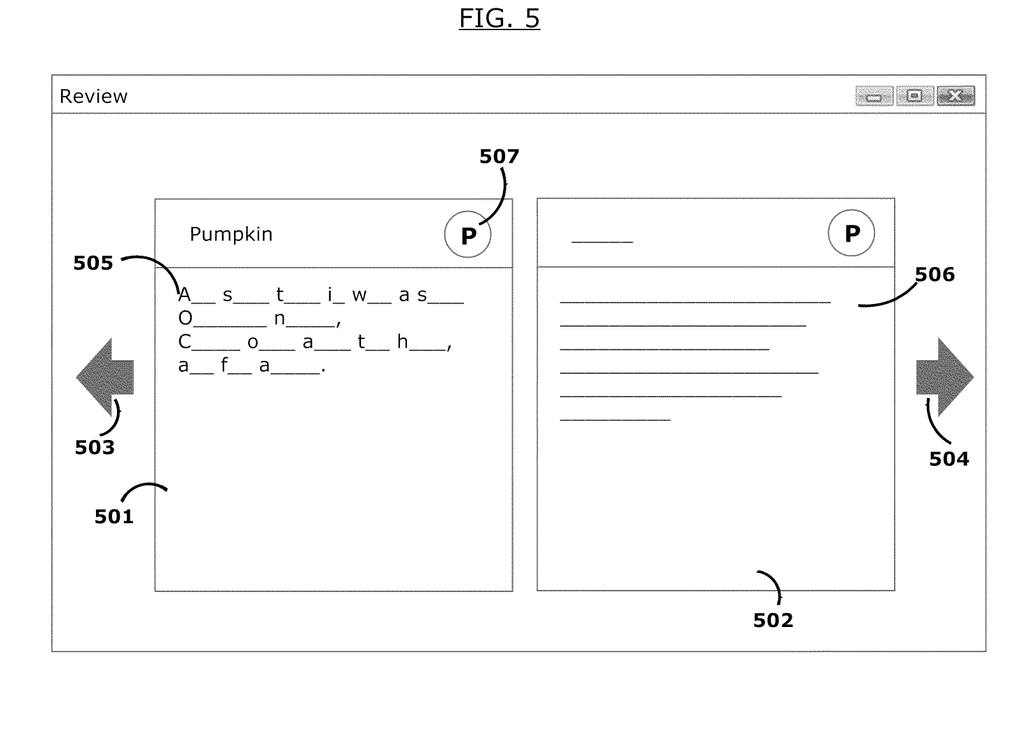

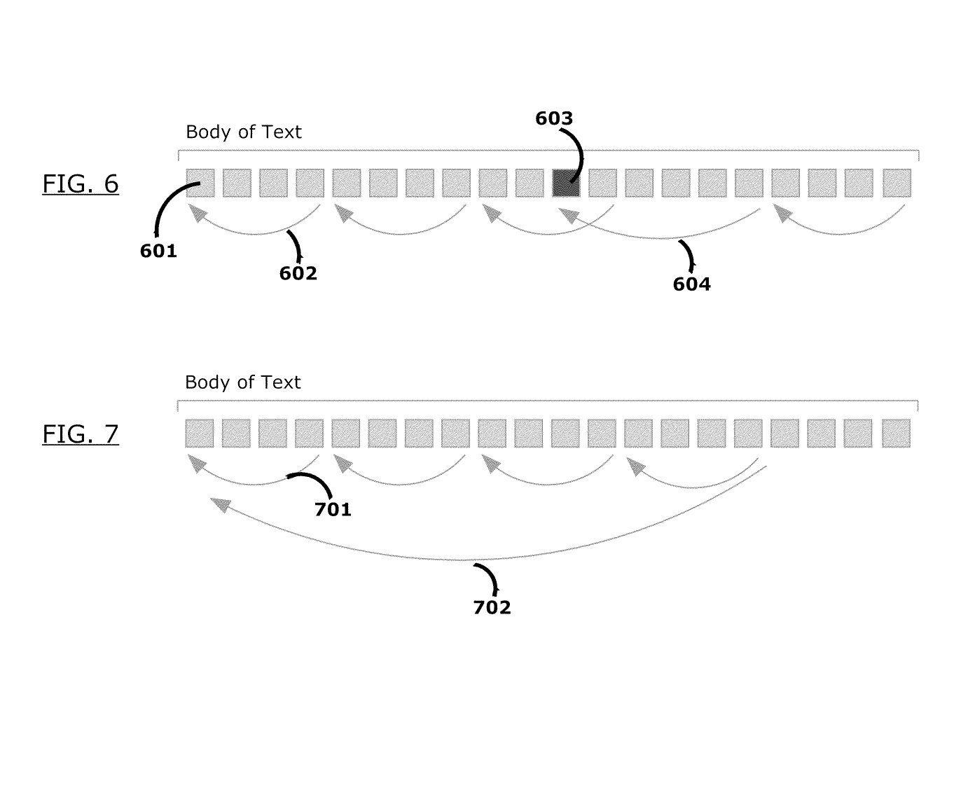

Also, if a problem is indicated during a review, the IRA will ensure that the group indicated as a problem will be reviewed a second time during the next round of reviews, increasing the R number until it encompasses the group indicated as a problem. FIG. 6 depicts this by representing the groups of text (601) and reviews (602). When a problem group is indicated (603), the subsequent review (604) is enlarged to include the problem group so it can be reviewed again.

The second phase of the IRA involves a faster, larger review of the just-learned material which occurs after four (4) or more of the small reviews used in the first phase. The user is taken further back into preceding groups for a final review before continuing on in the memorization process of the body of text. This final review is designed to further solidify the just-learned material into memory. FIG. 7 depicts this by showing the first-phase reviews (701) and, after four of them have elapsed, the second-phase review (702) is initiated, taking the user much further back in the sequence of groups. This second phase is also different from the first phase in that the review progresses without any delays for further review, even if the user indicates a problem group. Problem indications from the second-phase review process are used as data for the Spaced Repetition Algorithm later in the embodiment of this invention.

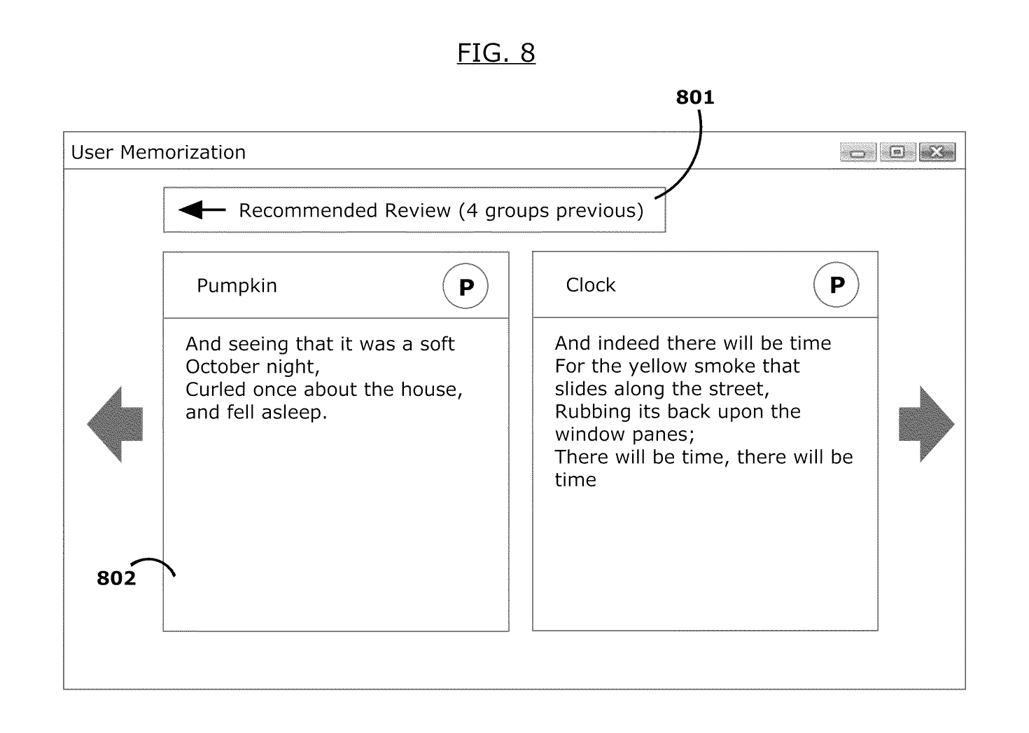

FIG. 8 depicts a software interface that could be used to recommend reviews to the user. A recommended review button (801) is placed above the groups (802). When clicked, it will take the user back to previous groups for a review according to the IRA.

Hinting Strategy Algorithm

A hinting strategy is a way to cue the user as to what the text of a group contains. The hinting strategies used in the preferred embodiment are as follows:

1) Showing only the first letters of each word.

2) Showing only the first letters of only even words.

3) Showing only the first letters of odd words.

4) Showing only the even words.

5) Showing only the odd words.

6) Showing only the first letters of random words.

7) Replacing underscores with every letter of every word in the group, leaving spaces between the words intact.

An embodiment of the present invention may also include a hinting strategy that analyzes user performance when certain words are present, and use that as a basis to determine which words are shown, or which letters are shown.

The Hinting Strategy Algorithm (HSA) is used to determine which hinting strategy is used and when. During the first review of a group, a hinting strategy from one through seven listed above is used. During reviews of subsequent groups, the hinting strategy will cycle through strategies one through seven in order to challenge the user and in order to avoid providing a memorization “crutch” that will keep the user from truly committing the material to memory. When a group is reviewed a second time, hinting strategy number seven is used. When reviewed a third time, no hinting strategy is used and the user is expected to recall it with no cue at all.

During scheduled reviews of problematic areas in the body of text (scheduled by the Spaced Repetition Algorithm), when the user is scheduled to start a review several groups before the groups that have been indicated as a problem, hinting strategies one through six are used to avoid frustration, build up momentum and build up confidence before the user starts reviewing problem groups. The problem groups will be given hinting strategy seven or no hint at all.

Spaced Repetition Algorithm

The Spaced Repetition Algorithm (SRA) is used to predict when the user is most likely to forget the information due for review. It does this using knowledge of how human memory works, and based on past performance of the user. Therefore, if the user regularly reviews the text in this way, it should never be forgotten.

Human memory works on a semi-logorithmic timeline. In order to retain learned material, the material only need be reviewed in ever increasing intervals. For example, recently learned material should be reviewed the next day. After that review, the material will still be well retained for another four days, when the material should be reviewed again. After that, it will be retained for around twelve days, where it will again be reviewed. This effect is where the name “spaced repetition” is derived. Here is a timeline for spaced repetition in the preferred embodiment:

1 day

4 days

12 days

20 days

35 days

60 days

90 days

150 days

270 days

365 days

730 days

1460 days

2190 days

4015 days

5475 days

Also factored into the SRA is the performance of the user. In the preferred embodiment, if, during an SRA-scheduled review, the user indicates problems on eight or more of the scheduled groups, the SRA timeline for those scheduled groups will be reset back to one day. If one to seven problems are encountered during an SRA-scheduled review of scheduled groups, the SRA timeline for those scheduled groups will be decreased, such that if it was previously scheduled for a review in 20 days, it would then be scheduled for review in 12 days. If any problems are encountered, the timeline review is always rescheduled at or below 12 days.

The SRA has two scheduling duties. 1) to schedule reviews of the entire body of text, and 2) to schedule reviews of groups indicated as problematic using the Problem Indicator. Priority is given to the reviews of the entire body of text, which are scheduled according to the SRA protocols above. When a review of the entire body is not scheduled, the SRA may schedule a review of groups that have been indicated as problematic.

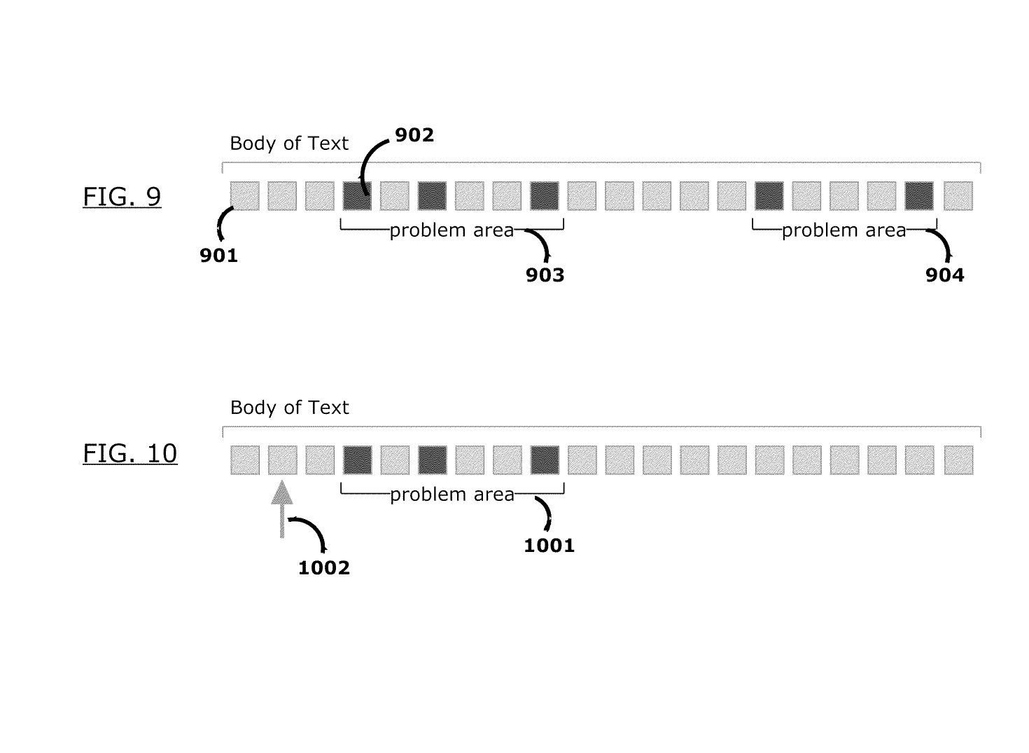

To do this, the SRA will endeavor to combine all the problem groups into areas, so as to make jumping from one section of the text to another section of the text happen as little as possible. It does this by combining all problem groups within five groups of each other into a single Problem Area (PA). FIG. 9 depicts this by showing groups (901) and problem groups (902) and how they are combined into problem areas (903 and 904). When the user reaches the end of a PA, the display will leap forward to the next PA. If no subsequent PA exists, the review process will have ended.

During a review of a PA, the user it taken to a section of the body of text completely out of context. This can be disorienting, so the SRA starts a review one or more groups before the scheduled PA, such that the user can get a kind of memory-based momentum going. FIG. 10 depicts this by showing a problem area (1001) and the start point for the review (1002).

Automated Grouping Process

The Automated Grouping Process (AGP) involves taking some minor input from the user, analyzing the body of text and then automatically separating the text into groups. This is more convenient than the manual grouping process described above and depicted in FIG. 2.

First, the AGP needs input from the user as to what kind of text is to be analyzed. In the preferred embodiment, a prompt will be displayed allowing the user to choose between options Poem, Script or Prose. Then, a second prompt will be displayed allowing the user to choose how many lines should be included in each group. Once selected, the AGP will use this data to determine how to differentiate between lines. For example, if the user selected Poem, the AGP will use hard breaks in the text to differentiate lines, since lines in a poem are each on their own separate line. If the user selected Prose, lines will be differentiated using periods. Therefore, if the user selected Prose and for there to be four lines per group, the AGP would include four sentences with four periods in each group.

While the above description contains much specificity, it should not be construed as limitations on the scope of the invention, but rather as an exemplification of one preferred embodiment thereof. Many other variations are possible. Accordingly, the scope of the invention should be determined not by the embodiment(s) illustrated, but by the appended claims and their legal equivalents.

What is claimed is:

1. A method for enhanced memorization of a body of text, the method comprising the steps of:
selecting a body of text for memorization;
without changing the relative word order of the body of text, dividing the body of text into parts;
presenting a part to a user for memorization;
scoring the user's ability to memorize the part; and,
using the score from the scoring step to schedule future user review of the part according to an algorithm for determining non-static intervals between scheduled reviews.

2. The method of claim 1, wherein future user review comprises the step of reviewing of a part by itself before entering a multi-part review mode, the multi-part review mode comprising user review of at least two different parts together.

3. The method of claim 2, wherein future user review further comprises the step of reviewing a part by itself after engaging in multi-part review mode.

4. The method of claim 1, further comprising the step of assigning a unique mnemonic aid to each part.

5. The method of claim 4, wherein a unique mnemonic aid comprises an image.

6. The method of claim 5, wherein a plurality of mnemonic aid images are related to each other.

7. The method of claim 6, wherein the plurality of mnemonic aid images comprise a story.

8. The method of claim 4, the unique mnemonic aid comprising spatial coordinates.

9. The method of claim 1, the method further comprising a tagging option, whereby the user can tag a part as problematic.

10. The method of claim 1, further comprising a hinting strategy module.

11. The method of claim 10, the hinting strategy module consisting of hinting strategies selected from the group consisting of showing only the first letters of each word;
showing only the first letters of only even words;
showing only the first letters of odd words;
showing only the even words;
showing only the odd words;
showing only the first letters of random words;
replacing underscores with every letter of every word in the part,
leaving spaces between the words intact; and,
a hinting algorithm that analyzes user performance when certain words are present to determine which words are presented to the user.

12. The method according to claim 10, the hinting strategy module comprising a first hinting phase, wherein the user is cycled through the available hinting strategies.

13. The method according to claim 12, further comprising a second hinting phase, wherein the user is presented with a hinting strategy only twice.

14. The method according to claim 1, wherein the non-static intervals are semi-logarithmic intervals.

15. The method according to claim 1, wherein the next scheduled review interval is reduced if the score from the scoring step falls below a passing score.

16. The method according to claim 1, wherein the next review interval will never exceed 12 days if the score from the scoring step falls below a passing score.

17. The method according to claim 1, the step of dividing the body of text into parts further comprising an automated dividing module.

18. The method according to claim 17, the automated dividing module comprising the step of asking the user to select the type of text to be reviewed.

19. The method according to claim 18, wherein if the user selects a poem, the automated dividing module will divide the body of text by line.

20. The method according to claim 18, wherein if the user selects prose, the automated dividing module will divide the body of text by sentence.

21. A method for enhanced memorization of a body of text, the method comprising the steps of:
selecting a body of text for memorization;
without changing the relative word order of the body of text, dividing the body of text into parts;
presenting a part to a user for memorization;
scoring the user's ability to memorize the part;
applying an immediate review algorithm to determine whether the user should review the part by itself or together with other parts in a multi-part mode; and,
using the score from the scoring step to schedule future user review of the part according to an algorithm for determining non-static intervals between scheduled reviews.

22. The method according to claim 21, wherein the immediate review algorithm comprises the step of assigning an R number to each part.

23. The method according to claim 22, the R number comprising two components, a first component varies according to the number of words in the part, and a second component varies according to the user's performance history in the scoring step.

24. The method according to claim 23, the R number further comprising a third component and the method further comprising a tagging option, whereby the user can tag a part as problematic, wherein the third component varies according to the number of times a user tags a part as problematic.

25. A method for enhanced memorization of a body of text, the method comprising the steps of:
a. selecting a body of text for memorization;
b. without changing the relative word order of the body of text, dividing the body of text into parts;
c. presenting a first consecutive part to a user for memorization;
d. scoring the user's ability to memorize the first consecutive part;
e. applying an immediate review algorithm to determine whether the user should review the part the first consecutive part by itself or together with other parts in a multi-part mode;
f. using the score from the scoring step to schedule future user review of the first consecutive part according to an algorithm for determining non-static intervals between scheduled reviews;
g. presenting the next consecutive part of the body of text to the user;
scoring the user's ability to memorize the next consecutive part;
applying an immediate review algorithm to determine whether the user should review the next consecutive part by itself or together with other parts in a multi-part mode;
using the score from the scoring step to schedule future user review of the next consecutive part according to an algorithm for determining non-static intervals between scheduled reviews; and,
h. repeating step g until the user has been presented with each part of the body of text in consecutive order.

26. A method for enhanced retention of consecutive text using specially timed reviews based on present and past performance, comprising the acts of:
selecting a body of text, the text comprising of a plurality of words and sentences which must follow one another consecutively;
separating the body of text into a plurality of smaller, but still consecutive, groups;
creating a means by which the user can view each group or multiple groups consecutively for the purposes of memorization or review;
creating a means by which the user can identify a group or a plurality of groups as problematic for him or her; and
creating a means to schedule a full review of the entire body of text based on performance analysis of problematic items and on spaced repetition algorithms.
